(19) United States
(12) Patent Application Publication
(10) Pub. No.: US 2001/0055674 A1
(43) Pub. Date: Dec. 27, 2001

(54) Multilayer, biaxially oriented polyester film, process for its production and its use as a magnetic tape film without a backing coating

(76) Inventors: Joerg Hellman, Mainz (DE); Wolfram Goerlitz, Wiesbaden (DE); Herbert Peiffer, Mainz (DE); Helmut Czepl, Eppstein (DE); Andreas Stopp, Ingelheim (DE)

Correspondence Address: PROPAT LLC, 2912 CROSBY ROAD, CHARLOTTE, NC, 28211, US

(21) Appl. No.: 09/896,190

(22) Filed: Jun. 29, 2001

Related U.S. Application Data
(63) Continuation-in-part of application No. 09/604,342, filed on Jun. 27, 2000.

(30) Foreign Application Priority Data
Jul. 5, 1999 (DE) 199 30 981.7

(51) Int. Cl. B32B 27/36; B32B 7/02

(52) U.S. Cl. 428/216; 428/220; 428/141; 428/148; 428/329; 428/330; 428/331; 428/480; 264/173.12; 264/556

(57) ABSTRACT

The invention relates to a three-layer, biaxially oriented polyester film which has very good electromagnetic properties compared with films of the prior art in combination with improved abrasion properties. The film is composed of at least one base layer B and outer layers A and C applied to both sides of this base layer, these outer layers having a defined number of protuberances with a defined height and having a defined gas flow in the roughness profile. The invention furthermore relates to a process for the production of the film and its use as magnetic tape film in which no backing coating is applied.

This application is a continuation-in-part application of U.S.S.N. 09/604,342 filed Jun. 27, 2000 by the same inventive entity.

### FIELD OF THE INVENTION

The invention relates to an at least three-layer, biaxially oriented polyester film which, in magnetic tapes without a backing coating, has substantially improved electromagnetic properties with optimized abrasion properties compared with films of the prior art and which is composed of at least one base layer B and outer layers A and C applied to both sides of this base layer, these outer layers being described by Rₐ values and R_{z} values and having a defined number of protuberances with a defined height, and furthermore the gas flow in the roughness profile of the surface of outer layer C being monitored, which can be achieved only by controlled mixing of pigment systems of different particle diameters. The specific haze of the film thus obtained is ≦0.4%/μm.

The invention furthermore relates to a process for the production of the film and its use, in particular as a magnetic tape film without a backing coating.

Particularly because of their excellent mechanical properties, polyester films have long been used as substrate material for magnetic recording materials. An optimal magnetic recording medium having good electromagnetic properties has a very smooth surface. In order to achieve good abrasion behavior for good processing behavior during coating and during subsequent use, the surface should also have a certain roughness. These essentially contradictory requirements can be met by monofilms (single-layer films) only through a certain readiness to compromise, since, in the case of these films, the optimization of one property is always at the expense of the other property.

### DESCRIPTION OF THE INVENTION

Coextruded multilayer films are known today (layer structure =AB, ABA and ABA′) and can be used to produce a so-called “dual surface” characteristic. Here, different properties (roughnesses, topography) can to a limited extent be imparted to the two film surfaces.

Thus, for example, U.S. Pat. No. 4,615,939 describes a “dual surface” film of the AB type, the two film surfaces having different Rₐ values. However, these films have the disadvantage that they cannot be produced economically since both layers—corresponding to two monofilms lying one on top of the other—have to contain particle systems and thus do not permit any cost reduction compared with monofilms. Moreover, the regenerated film (recycled product) which is obtained in every commercial production process and which is (necessarily) to be reused, which must be incorporated into at least one surface layer of the AB film adversely affects the quality of the magnetic tape film.

An improvement to this quality problem is achieved in U.S. Pat. No. 5,556,691 and U.S. Pat. No. 5,656,356 by the principle of ABA coextrusion. Here, the effect of the regenerated product on the film surface can be reduced by the shielding effect of the two outer layers A in that it is used specifically in the B layer. However, an ABA film generally externally exhibits the properties of a monofilm, i.e. the advantage of providing different surface properties cannot be utilized. The “dual surface” characteristic can however be established to a limited extent in the case of ABA films, by controlled variation of the thicknesses of the outer layers (A) . Such films are then usually referred to as ABA′ films (≠A/B/C). However, the disadvantage of these films is the still limited flexibility in the design of the surface topographies of the two film surfaces.

Individual ABC and ABCB films have also already been produced and described (U.S. Pat. No. 5,336,079), but here too at least one surface layer contains regenerated product—which has the disadvantages described above—or the information on ABC films is unspecific (European Patent Application No. 0 347 646).

It has already been proposed (file reference 19814710.4 of the German Patent Application) to establish the surface topographies of an at least three-layer film so that its surfaces are formed by outer layers A and C, a base layer B being present between these outer layers, the outer layer A having an Rₐ value of ≧15 nm and a R_{z} value of ≦150 nm and having a number of protuberances/projections Nₐ per 0.36 mm² which is related to their respective heights hₐ as follows:

Aₗ·e^{-B}₁^{·h}ₐ≦Nₐ≦A₂·e^{-B}₂·hₐ (1)

where A₁ =300, A₂ =7000

B₁=7.0, B₂ =8.0

0.01 μm ≦hₐ ≦1.0 μm and the outer layer C having an Rₐ value which is greater than that of the outer layer A and having a number of protuberances/projections Nₐ per 0.36 mm² which is related to their respective heights h_{c} as follows:

N_{c} <F·e^{-G·h}_{c} (2)

where F=20,000 and G=9.0 and the specific haze being ≦0.4%/μm.

It was furthermore proposed (U.S. Pat. No. 6,238,782) to establish the surface topographies of an at least three-layer film so that its surfaces are formed by outer layers A and C, a base layer B being present between these outer layers, and the outer layer A having a measured value for the gas flow in the roughness profile of >1000 sec. and >2000 sec. and the outer layer C having a measured value of <600 sec.

Films having surface topographies of the outer layer C, which has a number of protuberances or projections Nₐ per 0.36 mm² which is related to their respective heights h_{c} as follows:

F₁·e^{-G}₁¹^{·h}_{c}≧Nₐ≦F₂·e^{-G}₂^{·h}_{c} (3)

where F₁=8000, F₂=12,000

G₁=8.0,

G₂=12.0

0.01 μm ≦h_{c}<1.0 μm and additionally having measured values for the gas flow in the roughness profile on the surface C of ≦550 sec., have not yet been described.

### SUMMARY OF THE INVENTION

It was the object of the present invention to provide a coextruded, biaxially oriented multilayer polyester film which is suitable as a substrate material for magnetic recording media and at the same time has a smooth surface (for good electromagnetic properties of the magnetic tape) and a relatively rough surface (for good processing behavior in high-speed coating lines and good running behavior during subsequent operation of the tape) and low abrasion. Furthermore, the relatively rough surface (for good processing behavior in high-speed coating lines and good running behavior during subsequent operation of the tape) should be distinguished by a low transcription effect, which permits use in magnetic tapes without a backing coating.

Furthermore, the film should be capable of being prepared economically.

This object is achieved by a biaxially oriented, coextruded, at least three-layer polyester film whose two surfaces are formed by outer layers A and C, a base layer B being present between these outer layers, wherein the outer layer A has an Rₐ value of≦15 nm, an R_{z} value of ≦150 nm and a number of protuberances Nₐ per 0.36 mm² which is related to their respective heights hₐ as follows:

A₁·e^{-B}₁^{·h}ₐ≦Nₐ≦A₂·e^{-B}₂^{·h}ₐ (1)

where A₁=300, A₂=7000

B₁=7.0, B₂=8.0

0.01 μm ≦hₐ≦1.0 μm and the outer layer C has an Rₐ value which is greater than that of the outer layer A and has a number of protuberances N_{c} per 0.36 mm² which is related to their respective heights h_{c} as follows:

N_{c}≦F₂·e⁻₂^{·h}_{c} (3)

where F₂=12,000

G₂=12.0

0.01 μm ≦h_{c}≦1.0 μm the gas flow in the roughness profile of the surface of outer layer C is >550 sec.,

at least particle systems which are composed of two different particle diameters (d₅₀) in the range of 0.3-0.6 μm and of a particle concentration of 0.1-1% by weight are used, and the specific haze of the film thus obtained being ≦0.4%/μm.

### DETAILED DESCRIPTION OF THE INVENTION

In the context of the present invention, protuberances/projections are understood to mean conical protuberances/projections which project from the planar film surface. Protuberances and projections both meaning the same. These terms are used interchangeable in the art.

Roughnesses of Rₐ≦15 nm and R_{z}≦150 nm of the outer layer A carrying the magnetic coating are required for good electromagnetic properties. In addition, the number of protuberances/projections Nₐ per 0.36 mm² of film surface must be in the range described in equation (1) in order to achieve the desired electromagnetic properties of the outer layer A, according to equation (1). This range is specified by equation (1) for various heights of the protuberances/projections.

A defined density of protuberances/projections Nₐ per 0.36 mm² on the film surface to be magnetically coated is required for achieving good electromagnetic properties of the outer layer A. If the density is greater than the upper limit described in equation (1) for various heights hₐ, the electromagnetic properties will be poor (e.g. the signal/noise (S/N) ratio). If the density is less than the lower limiting range stated in equation (1), problems occur during coating of the tape.

A rough back (outer layer C) is required for achieving good running behavior and good abrasion behavior. The roughness of this outer layer must be greater than that of the outer layer A. For magnetic tapes without a backing coating, it was surprisingly found that, if the number of protuberances N_{c}/0.36 mm² of the relatively rough back is as described in equation (3), the electromagnetic properties of the magnetic layer could be improved without impairing the good running behavior and abrasion behavior of the back. This is specified by equation (3) for various heights of the protuberances/projections.

For achieving good running behavior and good abrasion behavior and for avoiding transcription of the protuberances on the rough back in the case of magnetic tapes without a backing coating onto the smooth magnetic layer (extruded onto outer layer A) in the wound magnetic tape, which contributes to an improvement of the electromagnetic properties of the magnetic layer, a defined density of protuberances/projections N_{c} per 0.36 mm² is required on the back (outer layer C). If the density is greater than the upper limit described in equation (3) for various heights h_{c}, the running behavior and the abrasion behavior of the back will be poorer.

To achieve good running behavior and good abrasion behavior while avoiding transcription of the rough back onto the smooth magnetic layer (extruded onto outer layer A) in the wound magnetic tape in the case of magnetic tapes without a backing coating, which contributes to an improvement in the electromagnetic properties of the magnetic layer, optimization of the film topography with regard to the gas flow in the roughness profile is also required. It has been found that gas flows of ≧550 sec. in the roughness profile are particularly suitable for electromagnetic properties, without adversely affecting the running behavior of the film.

If the measured values for the gas flow in the roughness profile are below the stated limit, the electromagnetic properties substantially deteriorate as a result of the transcription effect.

The number of protuberances N_{c}/0.36 mm² according to equation (3) of the relatively rough back which are required for achieving good running properties and good abrasion behaviour, and the gas flow of ≧550 sec. required in the roughness profile in order to avoid transcription of the rough back in the case of magnetic tapes without a backing coating onto the smooth magnetic layer (extruded onto layer A) in the wound magnetic tape, which clearly leads to an improvement in the electromagnetic properties, can be achieved only by the specific use of pigment systems comprising at least two different particle diameters (d₅₀) in the range from 0.3-0.6 μm in a particle concentration of 0.05-1% by weight.

The suitable combination of the particle diameters and particle concentrations is predetermined by the required number of protuberances N_{c}/0.36 mm² of the relatively rough back (equation 3) in combination with the gas flow in the roughness profile.

It has proven particularly expedient if the measured value for the gas flow in the roughness profile of the outer layer C is ≦600 sec., in particular >650 sec.

For comparable function, “dual surface” films of the AB type must be produced with a larger amount of particles, which is inevitably associated with an increase in the haze. Films according to the invention and having at least such functionality can be produced with considerably fewer particles, which leads to lower production costs and to lower haze values. The specific haze value of the films according to the invention is ≦0.4%/μm, the specific haze being defined as the haze of the film according to the standard ASTM-D 1003-61, divided by the total thickness of the measured film in μm.

It has proven particularly expedient if the Rₐ value of the outer layer A is preferably ≦13 nm, in particular ≦11 nm. The R_{z} value of this surface is preferably ≦130 nm, particularly preferably ≦110 nm. The topography of the outer layer A, expressed by equation (1), is preferred when A₁=500, in particular A₁=600, and/or A₂ preferably =6000, in particular 5000, and/or B₂ preferably =6.8, in particular B₁=6.6, and/or B₂ preferably =7.9, in particular B₂=7.8.

The outer layer C preferably has a roughness Rₐ≦25 nm, in particular ≦20 nm, very particularly preferably ≦18 nm, the condition that the roughness Rₐ of the outer layer C is always greater than that of the outer layer A furthermore being fulfilled. The topography of the outer layer C, expressed by equation (3), is preferred when F₂ preferably =11,500, in particular 11,000, and/or G₂ preferably =11.5, in particular G₂=11.0.

Preferred specific hazes for the film according to the invention are ≦0.35%/μm, in particular ≦0.30%/μm.

In the preferred and the particularly preferred embodiments, the film according to the invention is surprisingly distinguished by improved electromagnetic properties due to less pronounced transcription behavior.

For achieving the good electromagnetic properties and high abrasion resistance and improved (lower) transcription by the particles in the outer layers, the film according to the invention contains particles. The characteristics of the topography expressed by equations (1) and (3) is expediently controlled by varying the pigment concentration and/or the median particle size d₅₀ thereof. To achieve the topography of outer layer A according to equation (1), particle concentrations of 500 ppm to 10,000 ppm, preferably 800 ppm to 8000 ppm, in particular 1000 ppm to 6000 ppm with median particle sizes (d₅₀) of 0.1 μm to 2.0 μm, preferably 0.2 μm to 1.5 μm, in particular 0.3 μm to 1.0 μm, have proven suitable.

If the particles used are agglomeratable particles, such as Al₂O₃ or SiO₂, “median particle size” means their secondary particle size. Usually, the primary particle sizes of such particles are from 10 to 100 nm. The particle systems used can have a monomodal or, as a mixture of two or more particle systems, also a bimodal or multimodal distribution, said systems differing in their respective d₅₀ values in the case of the bimodal distribution. Particles having a narrow particle size distribution are preferably used.

For achieving the topographies of the outer layer C according to equation (3), particle concentrations of 1000 ppm to 15,000 ppm, preferably 2000 ppm to 12,000 ppm, in particular 3000 ppm to 10,000 ppm, with median particle sizes (d₅₀) of 0.1 μm to 2.0 μm, preferably 0.2 to 1.8 μm, in particular 0.3 μm to 1.5 μm, have proven suitable. If the particles used are agglomeratable particles, such as A₂O₃ or SiO₂, “median particle size” means their secondary particle size. Usually, the primary particle sizes of such particles are from 10 to 100 nm. The particle systems used can have a monomodal or, as a mixture of two or more particle systems, also a bimodal or multimodal distribution, said systems differing in their respective d₅₀ values in the case of the bimodal distribution. Particles having a narrow particle size distribution are preferably used.

According to the invention, the film is composed of at least three layers and has the outer layer A on one side of the layer B (=base layer) and a further outer layer C comprising polyethylene terephthalate on the other side of the layer B. Both outer layers contain the particles required for achieving the topographies of the film.

Fundamentally different raw materials may be used for the materials of the various layers. However, it is preferable to produce the individual layers on the basis of polyester raw materials.

The base layer B of the film preferably comprises at least 90% by weight of a thermoplastic polyester. Polyesters of ethylene glycol and terephthalic acid (=polyethylene terephthalate, PET), of ethylene glycol and naphthalene-2,6-dicarboxylic acid (=polyethylene 2,6-naphthalate, PEN), of 1,4-bishydroxymethylcyclohexane and terephthalic acid [=poly(1,4-cyclohexanedimethylene terephthalate), PCDT] and of ethylene glycol, naphthalene-2,6-dicarboxylic acid and biphenyl-4,4′-dicarboxylic acid (=polyethylene 2,6-naphthalate bibenzoate, PENBB) are suitable for this purpose. Polyesters which comprise at least 90 mol%, preferably at least 95 mol%, of ethylene glycol and terephthalic acid units or of ethylene glycol and naphthalene-2,6-dicarboxylic acid units are particular preferred. The remaining monomer units originate from other aliphatic, cycloaliphatic or aromatic diols or dicarboxylic acids, as may also occur in the layer A (or the layer C).

Suitable other aliphatic diols are, for example, diethylene glycol, triethylene glycol, aliphatic glycols of the general formula HO—(CH₂)n—OH, where n is an integer from 3 to 6 (in particular propane-1,3-diol, butane-1,4-diol, pentane-1,5-diol and hexane-1,6-diol), or branched aliphatic glycols having up to 6 carbon atoms. Among the cycloaliphatic diols, cyclohexanediols (in particular cyclohexane-1,4-diol) may be mentioned. Suitable other aromatic diols correspond, for example, to the formula HO—C₆H₄—X—C₆H₄—OH, where X is —CH₂, —C(CH₃) ₂—, —C (CF₃) ₂—, —◯—, —S— or —SO₂—. In addition, bisphenols of the formula HO—C₆H₄—C₆H₄—OH are also very suitable.

Other aromatic dicarboxylic acids are preferably benzenedicarboxylic acids, napthalenedicarboxylic acids (for example naphthalene-1,4-or-1,6-dicarboxylic acid), biphenyl-x,x′-dicarboxylic acids, (in particular biphenyl-4,4′-dicarboxylic acid), diphenylacetylene-x,x′-dicarboxylic acids (in particular diphenylacetylene-4,4′-dicarboxylic acid) or stilbene-x,x′-dicarboxylic acids. Among the cycloaliphatic dicarboxylic acids, cyclohexanedicarboxylic acids (in particular cyclohexane-1,4-dicarboxylic acid) may be mentioned. Among the aliphatic dicarboxylic acids, the (C₃—C₁₉) alkanedioic acids are particularly suitable, it being possible for the alkane moiety to be straight-chain or branched.

The preparation of the polyesters can be carried out by the transesterification process. Dicarboxylic esters and diols are used as starting materials and are reacted using the conventional transesterification catalysts, such as zinc, calcium, lithium, magnesium and manganese salts. The intermediates are then subjected to polycondensation in the presence of generally customary polycondensation catalysts, such as antimony trioxide or titanium salts. The preparation can equally well be carried out by the direct esterification process in the presence of polycondensation catalysts. There, the dicarboxylic acids and the diols are used directly as starting materials.

Processes which have proven advantageous are those which employ transesterification catalysts with which only a few and/or only small protuberances/projections are produced on the surface of the film. Magnesium and manganese salts are particularly preferred here. These transesterification catalysts are advantageously used in the preparation of the basic raw material, but particularly advantageously in the preparation of the raw material for the outer layers.

In principle, the polymers used for the outer layers may be the same as those used for the base layer. In addition, other materials may also be contained in the outer layers, in which case the outer layers preferably consist of a mixture of polymers, a copolymer or a homopolymer, which contain ethylene 2,6-naphthalate units and ethylene terephthalate units. Up to 10 mol% of the polymers may consist of further comonomers (see above).

For any intermediate layers present, it is possible in principle to use the same polymers as described above for the base layer and the outer layers.

The base layer and the other layers may additionally contain conventional additives, such as, for example, stabilizers and/or antiblocking agents. They are expediently added to the polymer or to the polymer blend before melting. The stabilizers used are, for example, phosphorus compounds, such as phosphoric acid or phosphoric esters.

Typical antiblocking agents (in this context also referred as particles) are inorganic and/or organic particles, for example calcium carbonate, amorphous silica, talc, magnesium carbonate, barium carbonate, calcium sulfate, barium sulfate, lithium phosphate, calcium phosphate, magnesium phosphate, alumina, LiF, calcium, barium, zinc or manganese salts of the dicarboxylic acids used, carbon black, titanium dioxide, kaolin or crosslinked polystyrene or acrylate particles.

Mixtures of two or more different antiblocking agents or mixtures of antiblocking agents of the same composition but different particle sizes may also be chosen as additives. The particles can be added to the individual layers in the respective advantageous concentrations, for example via master batches during the extrusion. Pigment concentrations of 0.1 to 5% by weight have proven particularly suitable. A detailed description of the antiblocking agents which can be used is to be found, for example, in U.S. Pat. No. 5,702,794 which is incorporated herein by reference.

The base layer of the film according to the invention is essentially without particles but may contain pigments in a controlled amount by the introduction of regenerated product (=recyclable film residues), this amount being chosen so that it does not adversely affect the number of protuberances/projections of the outer layers.

The polyester film according to the invention is composed of at least three layers and contains the two outer layers A and C. The thickness and composition of the second outer layer C can be chosen independently of the outer layer A, it being possible for the second outer layer likewise to contain the abovementioned polymers or polymer blends, which however need not be identical to the first outer layer. The second outer layer may also contain other conventional outer layer polymers. Preferably, the two outer layers are of the same thickness. The advantage of the film according to the invention is precisely that the different outer layer topographies can be established by controlled variation of the particle concentration and/or of the particle size in combination with essentially the same outer layer thickness.

If required, an intermediate layer may also be present between the base layer and the outer layers. Said intermediate layer can in turn consist of the polymers described for the base layer. In a particularly preferred embodiment, it consists of the polyester used for the base layer. It may also contain the additives described for the outer layers. The thickness of the intermediate layer is in general of the order of magnitude of the thicknesses of the outer layers.

In the case of the three-layer film according to the invention, the thicknesses of the outer layers A and C are in general greater than 0.2 μm and are in the range from 0.3 to 2.5 μm, preferably in the range from 0.5 to 2.0 μm, particularly preferably in the range from 0.7 to 1.8 μm, it being possible for the outer layers A and C to be of the same or different thickness. Preferably, they have essentially the same thickness.

The total thickness of the polyester film according to the invention may vary within wide limits. It is from 5 to 40 μm, in particular from 7 to 20 μm, preferably from 9 to 15 μm.

For the production of the layers A and C (outer layers A and C), granules of polyethylene terephthalate are fed in each case to an extruder. The materials are melted and extruded at about 300° C.

The polymers for the base layer are expediently fed in via a further extruder. Any foreign bodies or impurities present can be filtered off from the polymer melt prior to extrusion. The melts are then shaped into flat melt films in a coextrusion die and laminated with one another. Thereafter, the multilayer film is taken off and solidified with the aid of a chill roll and, if required, further rolls.

The biaxial orientation is generally carried out sequentially. Orientation is preferably carried out first in the longitudinal direction (i.e. in the machine direction) and then in the transverse direction (i.e. perpendicular to the machine direction). This leads to orientation of the molecular chains. The orientation in the longitudinal direction can be carried out with the aid of two high-speed rolls differing according to the intended orientation ratio. For transverse orientation, an appropriate tenter frame is generally used.

The temperature at which the orientation is carried out may vary within a relatively large range and depends on the required properties of the film. In general, the longitudinal orientation is carried out at from 80 to 130° C. and the transverse orientation at from 90 to 150° C. The longitudinal stretching ratio is in general from 2.5:1 to 6:1, preferably from 3:1 to 5.5:1. The transverse orientation ratio is in general in the range from 3.0:1 to 5.0:1, preferably from 3.5:1 to 4.5:1.

Prior to the transverse orientation, one or both surface(s) of the film can be coated in-line by the known methods. The in-line coating can serve, for example, for improved adhesion of the magnetizable layer but also for improvement of the antistatic behavior or of the processing behavior.

In the subsequent heat-setting, the film is kept at a temperature of from 150 to 250° C. for from about 0.1 to 10 s. The film is then wound in a conventional manner.

The biaxially oriented and heat-set polyester film can be corona— or flame-treated before application of the magnetizable layer to one or both sides. The intensity of treatment is chosen so that the surface tension of the film is in general greater than 45 mN/m.

If desired, the application of the magnetizable layers is effected on conventional industrial lines.

One advantage of the invention is that the production costs for the film according to the invention are lower than those according to the prior art. Those properties of the film according to the invention which are relevant to processing and use are tailored to the desired properties. The film wastes obtained during the production of the film are recycled as regenerated product without loss of quality.

The film is outstandingly suitable as film support for magnetic tapes without a backing coating.

In summary, the film according to the invention is distinguished by good electromagnetic properties in combination with high abrasion resistance and improved and negligible transcription behavior. Furthermore, the film is distinguished by good antistatic properties. Moreover, it has the desired good processing behavior, in particular outstanding cuttability and winding properties.

The table below (Table 1) once again summarizes the most important film properties according to the invention.

TABLE 1

| | Range | | | | |
|---|---|---|---|---|---|
| | according | | | | Method of |
| | to the | | In | | measure- |
| | invention | Preferred | particular | Unit | ment |
| Rₐ (A) | ≦15 | ≦13 | ≦11 | nm | DIN4768 |
| R_{z} (A) | 150 | ≦130 | ≦110 | | DIN4762 |
| A₁/A₂ | 300/7000 | 500/6000 | 800/5000 | Nₐ/0.36 mm² | |
| B₁/B₂ | 7.0/8.0 | 6.8/7.9 | 6.6/7.8 | | |
| Rₐ (C) | <25 | <20 | <18 | | DIN4768 |
| F₂ | 12,000 | 11,500 | 11,000 | N_{c}/0.36 mm² | |
| G₂ | 12.0 | 11.5 | 11.0 | | |
| Measured | >550 | >600 | >650 | sec. | as |
| value of | | | | | described |
| the gas | | | | | |
| flow | | | | | |
| (outer | | | | | |
| layer C) | | | | | |
| Specific | 0.4 | 0.35 | 0.3 | %/μm | ASTM-D |
| haze | | | | | 1003-61 |

The following methods were used for characterizing the raw materials and the films:

Determination of the Roughness

The roughness Rₐ of the film was determined according to DIN 4762 at a cut-off of 0.08 mm.

| | |
|---|---|
| Apparatus | Perthometer S8P (from Mahr Feinprüf) |
| | on glass plate |
| Tracer | RFHTB-50 with runner |
| Needle diameter | 5 μm |
| Applied force | 0.4 mN |
| Spacer runner | −25 mm |

Determination of the Specific Haze

The haze of the film was determined according to ASTM-D 1003-61 (method of measurement A) using the measuring apparatus XL-211 hazemeter from BYK Gardner. The specific haze is defined as:

$$Specific haze = \frac{Haze}{Total layer thickness} \frac{\%}{μ m}$$

Determination of the number of protuberances on film surfaces by shadow topography. The determination of the size distribution of protuberances on film surfaces is carried out using a scanning electron microscope and an image analysis system. The scanning electron microscope XL30 CP from Philips, with an integrated image analysis program AnalySIS from Soft-Imaging System, is used.

For these measurements, film samples are applied flat onto a sample holder. A thin metal layer (e.g. of silver) is then applied to them at an angle a by an oblique shadowing vapor deposition method. a is the angle between the sample surface and the propagation direction of the metal vapor. This oblique vapor deposition results in a shadow behind the protuberance. Since the shadows are not yet electrically conductive, the sample then additionally has a second metal (e.g. gold) applied to it by vapor deposition or sputtering, the second coating striking at right angles to the sample surface and hence no shadows being formed during the second coating.

The sample surfaces prepared in this manner are imaged in a scanning electron microscope (SEM). The shadows of the protuberances are visible owing to the material contrast of the metals. The sample is oriented in the SEM such that the shadows are parallel to an edge of the image. The following conditions are set on the SEM for imaging: secondary electron detector, working distance 10 mm, acceleration voltage 10 kV and spot 4.5. The brightness and contrast are adjusted so that all image information is represented as gray values and the intensity of the background noise is so low that it is not detected as shadow. The length of the shadows is measured using the image analysis. The threshold value for shadow detection is set at the point where the second derivative of the gray value distribution of the image intersects the zero point. Prior to shadow detection, the image is smoothed with an N×N filter (size 3, 1 iteration). By setting a frame, it is ensured that protuberances which are not completely present in the image are not also measured. The magnification, the frame size and the number of images evaluated are chosen so that altogether a film surface of 0.36 mm² is evaluated.

The height of the individual protuberances is calculated from the individual shadow lengths using the following relationship:

h=(tan α)·L (4)

where h is the height of the protuberance, α is the vapor deposition angle and L is the shadow length. The protuberances thus determined are divided into classes in order to obtain a frequency distribution. The division is into 0.05 μm wide classes between 0 and 1 μm, the smallest class (from 0 to 0.05 μm) not being used for further evaluations.

Determination of the Electromagnetic Properties (EMP)

The electromagnetic properties were determined according to DIN IEC 60 B (CO) 69. In each case the outside (coextrusion layer A) of the films was, by the known methods, magnetically coated, calendered and evaluated for determining the electromagnetic properties. The thickness of the magnetic layer is typically from 2.0 to 2.8 μm. No backing coating was applied.

Abrasion Resistance

The abrasion resistance was determined using a converted audio tape machine. The equipment of the apparatus includes two measuring devices (2 and 3) for monitoring the tape tension and a pin (1) over which one side of the surface of the film is drawn at a defined speed and a defined angle (θ). The abrasion produced on the pin is classified by means of optical and microscopic methods (−=considerable abrasion, O=abrasion comparable with the standard, +=better than standard, ++=little abrasion).

To assess the abrasion resistance, corresponding narrow sections 1 cm wide and 200 meters long were prepared. The abrasion resistance was determined in each case only on the film side which was subsequently used as the back of the magnetic tape.

| | |
|---|---|
| Tape speed | 19 cm/sec. |
| Tape tension | 200 g |
| Contact angle | 135° |
| Pin | SUS 204 2S, 6 mm, CrO₂ surface |

Surface Gas Flow Time

The principle of the method of measurement is based on the air flow between one side of the film and a smooth silicon wafer. The air flows from the vicinity of an evacuated space, the interface between film and silicon wafer providing resistance to flow.

A circular film sample is placed on a silicon wafer, in the center of which a hole provides the connection to the receiver. A weight is placed on the sample. The receiver is evacuated to a pressure of less then 0.1 mbar. The time [sec.] required by the air to produce a pressure increase of 56 mbar in the receiver is determined.

Measuring conditions:

| | | |
|---|---|---|
| Measured area | 45.1 | [cm²] |
| Weight | 1276 | [g] |
| Air temperature | 23 | [° C.] |
| Atmospheric humidity | 50 | [%] rel. humidity |
| Air pressure | 1 | [bar] |
| Gas volume collected | 1.2 | [cm³] |
| Pressure interval | 56 | [mbar] |

### EXAMPLES 1 AND 2

Chips of polyethylene terephthalate (prepared by the transesterification process with Mn as transesterification catalyst, Mn concentration: 100 ppm) and recycled product of the same type and having a total particle concentration of 1150 ppm (CaCO₃<1.0 μm; Al₂O₃ 0.06 μm) were dried at 135° C. to a residual moisture content of less than 50 ppm and fed to the extruder for the base layer B.

In addition, mixtures of chips of polyethylene terephthalate (prepared by the transesterification process with Mn as transesterification catalyst, Mn concentration: 100 ppm), which contain particles according to Table 2, were fed, without drying, to the respective twin-screw extruders for the outer layers A and C.

A transparent three-layer A/B/C film having a total thickness of 15 (13) μm was produced by coextrusion and subsequent stepwise orientation in the longitudinal and transverse direction. The thickness of the respective outer layers was regulated by means of the coextruder throughput and adjusted in each case to 1 μm.

Base layer B:

| | |
|---|---|
| 50.0% by weight | of polyethylene terephthalate having |
| | an SV value of 770 |
| 50.0% by weight | of recycled product having an SV |
| | value of 730 |

The production conditions in the individual process steps were:

| | | |
|---|---|---|
| Extrusion: | Temperatures: | A layer: 290° C. |
| | | B layer: 290° C. |
| | | C layer: 290° C. |
| Longitudinal | Temperature: | 80-125° C. |
| orientation: | Longitudinal | 4.7 |
| | orientation ratio: | |
| Transverse | Temperature: | 80-135° C. |
| orientation: | Transverse | 4.0 |
| | orientation ratio: | |
| Setting: | Temperature: | 210-225° C. |

### COMPARATIVE EXAMPLES 1 TO 4

For Comparative Examples 1 to 4, the procedure according to the technical description for Examples 1 and 2 was followed. The pigmentation of the outer layers is shown in Table 3.

TABLE 2

| | Layer A | | | Layer C | | | Roughness | |
|---|---|---|---|---|---|---|---|---|
| | | | Al₂O₃ | | | Al₂O₃ | Rₐ/R_{z} | Rₐ/R_{z} |
| | CaCO₃ | | d₅₀ = | CaCO₃ | | d₅₀ = | A | C |
| Exam- | d₅₀ | | 0.06 μm | d₅₀ | | 0.06 μm | (outer) | (inner) |
| ple | [μm] | % | % | [μm] | % | % | [nm] | [nm] |
| 1 | 0.6 | 0.2 | ./. | 0.4 | 0.3 | 0.3 | 7/56 | 11/78 |
| | | | | 0.6 | 0.3 | | | |
| 2 | 0.6 | 0.2 | ./. | 0.4 | 0.35 | 0.3 | 7/55 | 12/89 |
| | | | | 0.6 | 0.25 | | | |

Examples 1 and 2, ABC (layer thickness A=C=1 μm, B=13 μm) Stated percentages are % by weight.

TABLE 3

| Com- | | | | | | | | |
|---|---|---|---|---|---|---|---|---|
| para- | Layer A | | | Layer C | | | Roughness | |
| tive | | | Al₂O₃ | | | Al₂O₃ | Rₐ/R_{z} | Rₐ/R_{z} |
| Ex- | CaCO₃ | | d₅₀ = | CaCO₃ | | d₅₀ = | A | C |
| am- | d₅₀ | | 0.06 μm | d₅₀ | | 0.06 μm | (outer) | (inner) |
| ple | [μm] | % | % | [μm] | % | % | [nm] | [nm] |
| 1 | 0.6 | 0.2 | ./. | 0.4 | 0.55 | 0.3 | 7/57 | 12/78 |
| | | | | 0.8 | 0.06 | | | |
| 2 | 0.6 | 0.45 | ./. | 0.4 | 0.5 | 0.45 | 12/81 | 13/89 |
| | | | | 0.7 | 0.4 | | | |
| 3 | 0.6 | 0.45 | ./. | 0.4 | 0.5 | 0.45 | 11/72 | 11/94 |
| | | | | 0.7 | 0.1 | | | |
| 4 | 0.6 | 0.2 | ./. | 0.4 | 0.5 | 0.45 | 7/55 | 13/87 |
| | | | | 0.7 | 0.4 | | | |

Comparative Examples 1 to 4, ABC (layer thickness A = C = 1 μm, B = 13 μm)
Stated percentages are % by weight.

Table 4 clearly shows that films whose topography is in the range according to the invention have better (Example 1) and outstanding (Example 2) electromagnetic properties (EMP) in combination with good abrasion resistances. In particular, the variation in the parameters F and G of the C layer and the measured value of the gas flow in the roughness profile for the C layer show how these affect the electromagnetic properties. In the examples according to the invention, the EMP were improved by up to 0.5-1 dB compared with the standard (Comparative Examples 1-4).

TABLE 4

| | | | | | | | | | | Abra- |
|---|---|---|---|---|---|---|---|---|---|---|
| | | | | | | | | Air- | | sion |
| | | | Spec. | | | | | flow | | resist- |
| Ex. | Ra (A) (nm) | Ra (C) (nm) | haze | A | B | F | G | A/C | EMP | ance |
| 1 | 7 | 11 | 0.2 | 2050 | −7.4 | 10,533 | −9.7 | 930/ | ++ | + |
| | | | | | | | | 690 | | |
| 2 | 7 | 12 | 0.2 | 1900 | −7.1 | 11,598 | −10.8 | 930/ | ++ | + |
| | | | | | | | | 720 | | |

TABLE 5

| | | | | | | | | | | Abra- |
|---|---|---|---|---|---|---|---|---|---|---|
| | | | | | | | | Air- | | sion |
| | | | Spec. | | | | | flow | | resist- |
| Ex. | Ra (A) (nm) | Ra (C) (nm) | haze | A | B | F | G | A/C | EMP | ance |
| 1 | 7 | 12 | 0.2 | 2050 | −7.4 | 14,176 | −10.9 | 930/570 | 0 | 0 |
| 2 | 12 | 13 | 0.3 | 4540 | −8.1 | 10,125 | −9.0 | 610/480 | 0 | ++ |
| 3 | 11 | 11 | 0.3 | 4550 | −8.0 | 14,472 | −11.7 | 610/730 | 0 | + |
| 4 | 7 | 13 | 0.3 | 2000 | −7.5 | 10,125 | −9.0 | 930/480 | 0 | + |

− Poor
0 Standard
+ Good
++ Very good

Table 5 shows that films according to the prior art (ABC) do not achieve the set object of improved electromagnetic properties for magnetic tapes without a backing coating.

Comparative Examples 1 and 3 show that when the number N_{c} of the protuberances h_{c}, expressed with the aid of the parameters F and G, is outside (above) the claimed limit but the measured value for the gas flow in the roughness profile is in the claimed range, the electromagnetic properties do not meet the requirements.

Comparative Examples 2 and 4 show that when the number N_{c} of the protuberances h_{c}, expressed with the aid of the parameters F and G, are in the claimed range but the measured value for the gas flow in the roughness profile is outside the claimed range, the electromagnetic properties likewise do not meet the requirements.

Comparative Examples 2 and 4 furthermore show that the influence of the layer A, described by the number Nₐ of the protuberances hₐ, expressed with the aid of the parameters A and B, on the electromagnetic properties of magnetic tapes without a backing coating is surprisingly of minor importance.

We claim:

1. A biaxially oriented, coextruded, at least three-layer polyester film, the at least three layers being mainly composed of polyester, the two surfaces of which film are formed by outer layers A and C, a base layer B being present between these outer layers, wherein the outer layer A
has a number of protuberances/projections Nₐ
per 0.36 mm² which is related to their
respective heights ha as follows:
A₁·e^{-B}₁^{·h}ₐ≦Nₐ≦A₂·e^{-B}₂^{·h}ₐ (1)
where A₁=300, A₂=7000
B₁=7.0, B₂=8.0 and
0.01 μm <h_{A}<1.0 μm and the outer layer C
has an Rₐ value which is greater than that of the outer layer A and a
number of protuberances/projections N_{c} per 0.36 mm² which is related to their respective heights h_{c} as follows:
N_{c}<F₂·e^{-G}₂^{·h}_{c} (3)
where F₂=12,000
G₂=12.0
0.01 μm ≦h_{c}<1.0 μm and the gas flow in the roughness profile of the surface of outer layer C is >550 sec.

2. The film as claimed in claim 1, wherein particle systems which are composed of two different particle diameters (d₅₀) in the range of 0.3-0.6 μm and which are contained in each case in a particle concentration of 0.1-1% by weight (based on the weight of the outer layer) are used in the outer layer C.

3. The film as claimed in claim 1 or 2, wherein the specific haze of the film is ≦0.4%/μm.

4. The film as claimed in claim 1, wherein the outer layer A contains particles.

5. The film as claimed in claim 4, wherein the outer layer A contains particles in a concentration of 500 ppm to 10,000 ppm, based on the weight of the outer layer.

6. The film as claimed in claim 4 or 5, wherein the median particle size d₅₀ of the particles in the outer layer A is between 0.2 μm and 2.0 μm.

7. The film as claimed in claim 1, wherein the different topographies of the outer layers A and C, expressed by equations (1) and (3), are established by varying the concentration of the particles in the outer layers A and C or by different median particle sizes d₅₀ of the particles in the outer layers A and C.

8. The film as claimed in claim 1, wherein the different topographies of the outer layers A and C, expressed by equations (1) and (3), are established by varying the concentration of the particles in the outer layers A and C and by different median particle sizes d₅₀ of the particles in the outer layers A and C.

9. The film as claimed in claim 1, wherein the outer layer thicknesses of the outer layers A and C, independently of one another, are identical or different and are from 0.3 to 2.5 μm.

10. The film as claimed in claim 1, wherein the total film thickness is from 5 μm to 40 μm.

11. The film as claimed in claim 1, wherein the base layer B contains regenerated film material.

12. A process for the production of a biaxially oriented, coextruded, at least three-layer polyester film as claimed in claim 1, in which polyester melts corresponding to the compositions of the outer and base layers are fed to a coextrusion die and are extruded from this onto a chill roll and the prefilm thus obtained is then biaxially oriented and heat-set, the outer layer A
having a number of protuberances/projections Nₐ per 0.36 mm² which is related to their respective heights hₐ as follows:
A₁·e^{-B}₁^{·h}ₐ≦Nₐ≦A₂·e⁻₂^{·h}ₐ (1)
where A₁=300, A₂=7000
B₁=7.0, B₂=8.0 and
0.01 μm ≦h_{A}≦1.0 μm and the outer layer C
having an Rₐ value which is greater than that of the outer layer A and a
number of protuberances/projections N_{c} per 0.36 mm² which is related to their respective heights h_{c} as follows:
N_{c}≦F₂·e^{-G}₂^{·h}_{c} (3)
where F₂=12,000
G₂=12.0
0.01 μm ≦h_{c}≦1.0 μm and the gas flow in the roughness profile of the surface of outer layer C being >550 sec.

13. A magnetic recording medium comprising a film as claimed in claim 1 and a magnetizable layer applied to a surface of the film.

14. The magnetic recording medium as claimed in claim 12, wherein the magnetizable layer is applied to the outer layer A.
